(19) United States
(12) Patent Application Publication
(10) Pub. No.: US 2007/0271712 A1
(43) Pub. Date: Nov. 29, 2007

(54) Process for Dyeing Cellulosic Fibre Materials With at Least Two Vat Dyes

(76) Inventors: Peter Scheibli, Binningen (CH); Rainer Hildebrand, Lorrach (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/576,057

(22) PCT Filed: Nov. 1, 2004
(86) PCT No.: PCT/EP04/52740

§ 371 Date: May 11, 2007

(30) Foreign Application Priority Data
Nov. 10, 2003 (EP) 03104133.8

(51) Int. Cl. D06P 1/22; C09B 7/00; D06P 1/24; D06P 3/60; C09B 9/02

(52) U.S. Cl. 8/650

(57) ABSTRACT

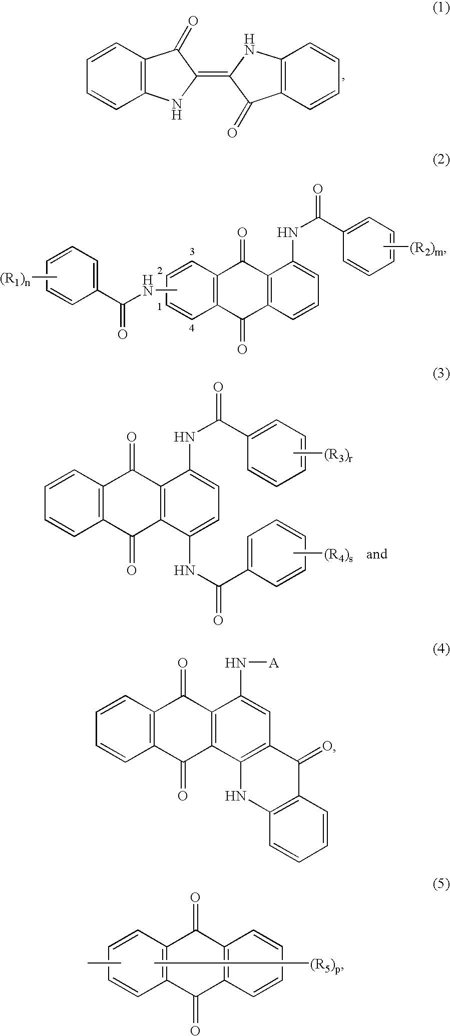

A process for dyeing cellulosic fibre materials, wherein the fibre material is brought into contact with at least two dyes from the group of formulae (1), (2), (3) and (4) wherein A is hydrogen or a radical of formula (5), R₁, R₂, R₃ and R₄ are each independently of the other halogen, C₁-C₄alkyl, C₁-C₄alkoxy, nitro, benzoylamino which is unsubstituted or substituted in the phenyl ring, or unsubstituted or substituted amino, n, m, r and s are each independently of the others the number 0, 1, or 2, and p is the number 0, 1, 2, 3 or 4, produces level, tinctorially strong dyeings.

The present invention relates to a process for dyeing cellulosic fibre materials with a mixture of at least two vat dyes.

The dyeing of cellulosic textile materials with vat dyes is generally known. In order to give the water-insoluble vat dye the required substantivity, that is to say in order to fix it on the textile material, it must first be converted into a substantive water-soluble leuco form by reduction (vatting) and then developed to the dye pigment again by oxidation.

In the dyeing of denim goods, normally the only dye used is indigo and the only fibre used is 100% cotton. In a single-pass dyeing operation, only about 10 to 20% of leuco indigo is absorbed by the fibres. Because of this low bath exhaustion, dyeing with indigo by batchwise exhaust processes is not very widespread. It is therefore usual to carry out the dyeing process continuously in several passes, i.e. in several steps. Very long machines having from 8 to 10 units are accordingly used, each unit consisting of an application device for the vat (padding machine) and a subsequent air pass for reoxidation. In this process, which allows only yarn in the form of a rope or hank or in the form of a warp sheet to be dyed, but not piece goods or wound packages, the vatted indigo dye is applied from a plurality of dye liquors of large volume that have a low dye concentration, by repeated brief immersion and also squeezing out and oxidation in the intermediate air passes.

The vat is at room temperature in all cases, and the padding machine is therefore not heatable. In this manner there is obtained an indigo dyeing in which virtually only the outer fibres of the yarns are coloured by the dye, and those fibres are themselves dyed only very superficially (ring dyeing). By abrasion in stone-wash treatments, the dye is rubbed away especially on exposed areas of the made-up denim article. As a result, the readily visible ageing process desired by the market is obtained, that process also continuing during domestic washing.

Two types of machine are usually used for dyeing warp yarn for denim, the hank or rope dyeing machine, in which the warp yarns are brought together to form a plurality of hanks or ropes (rope dyeing), or the open-width dyeing machine, in which the warp yarn is dyed in open width (slasher dyeing). A sizing process is integrated into the dyeing process. There-after, the dyed yarn is woven with an undyed, raw weft yarn.

The colour yield of indigo in the region of about pH 11 is substantially higher than at pH 12.5 to 13. In addition, the diffusion of indigo into the fibres is greater in the higher pH range, which reduces the surface effect desired for jeans. Furthermore, it is extraordinarily difficult using conventional processes to maintain the pH in the desired range of about 11. Moreover, in industrial indigo dyeing machines not all the dye baths have an alkali metering unit with pH monitoring.

In addition to traditional blue jeans there is a demand for denim goods that include other colour shades and likewise exhibit the desired “stone-wash” effect. However, unlike indigo, most vat dyes are in their leuco form distinguished by a higher affinity for the fibres and accordingly by higher bath exhaustion, making it virtually impossible for ring-dyed yarn to be produced under the conditions of indigo dyeing. Such vat dyes cannot therefore be applied under the conventional conditions of indigo dyeing.

The problem underlying the present invention is to provide a process for dyeing cotton in other non-indigoid shades, which process can be carried out under the conditions of indigo dyeing using conventional types of machine and makes a broad spectrum of colours accessible.

The present invention accordingly relates to a process for dyeing cellulosic fibre materials, wherein the fibre material is brought into contact with at least two vat dyes from the group of formulae 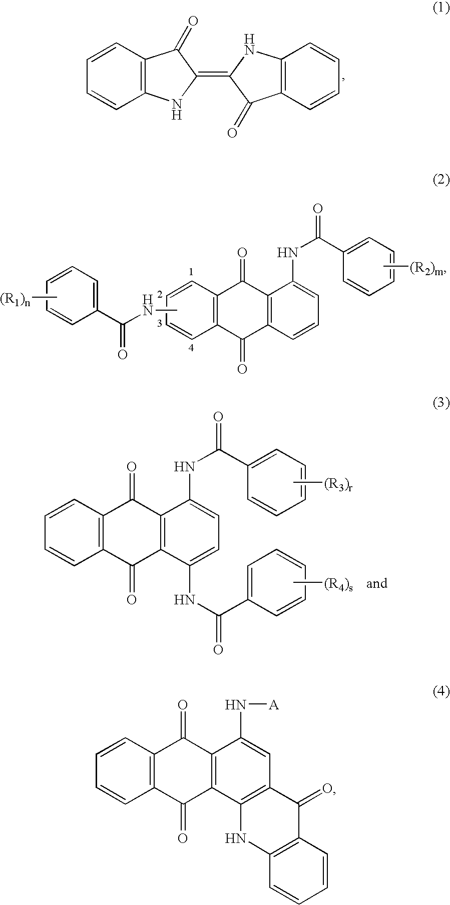
wherein

A is hydrogen or a radical of formula

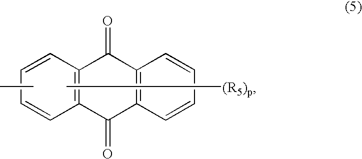

R₁, R₂, R₃, and R₄ is halogen, C₁-C₄alkyl, C₁-C₄alkoxy, nitro, benzoylamino which is unsubstituted or substituted in the phenyl ring, or unsubstituted or substituted amino,

n, m, r and s are each independently of the others the number 0, 1 or 2, and

p is the number 0, 1, 2, 3 or 4.

When the indices n, m, r, s and p are a number greater than 1, e.g. 2, the radicals R₁, R₂, R₃, R₄ and R₅ may each have identical or different meanings.

There come into consideration as C₁-C₄alkyl for R₁, R₂, R₃, R₄ and R₅ independently of one another, for example, methyl, ethyl, n-propyl, isopropyl, n-butyl, sec-butyl, isobutyl or tert-butyl, preferably methyl or ethyl and especially methyl.

There come into consideration as C₁-C₄alkoxy for R₁, R₂, R₃, R₄ and R₅ independently of one another, for example, methoxy, ethoxy, n-propoxy, isopropoxy, n-butoxy or isobutoxy, preferably methoxy or ethoxy and especially methoxy.

There come into consideration as halogen for R₁, R₂, R₃, R₄ and R₅ independently of one another, for example, fluorine, chlorine, bromine or iodine, preferably chlorine or bromine and especially chlorine.

R as benzoylamino is unsubstituted or may be substituted in the phenyl ring, for example by halogen, nitro, C₁-C₄alkyl or C₁-C₄alkoxy, preferably by halogen, C₁-C₄alkyl or C₁-C₄alkoxy and, especially, by halogen or C₁-C₄alkyl, for example chlorine or methyl.

R₅ as unsubstituted or substituted amino is, for example, amino or amino mono- or di-substituted by C₁-C₄alkyl or phenyl, it being possible for the phenyl ring in turn to be substituted, for example by halogen, nitro, C₁-C₄alkyl or C₁-C₄alkoxy, preferably by halogen, C₁-C₄-alkyl or C₁-C₄alkoxy and, especially, by halogen or C₁-C₄alkyl, for example chlorine or methyl. Examples that may be mentioned include methylamino, dimethylamino, ethylamino, diethylamino and anilino.

Preferably, R₁, R₂, R₃, R₄ and R₅ are each independently of the others halogen or C₁-C₄alkyl, especially chlorine or methyl.

Preferably, n, m, r and s are each independently of the others the number 0 or 1.

Preferably, p is the number 0, 1 or 2, especially 0 or 1.

In the dye of formula (2), the radical of the formula 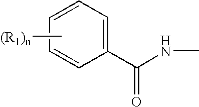
is bonded to the anthraquinone preferably at the 1- or 4-position of the condensed benzene ring. Suitable dyes of formula (2) are, for example, the dyes of formulae 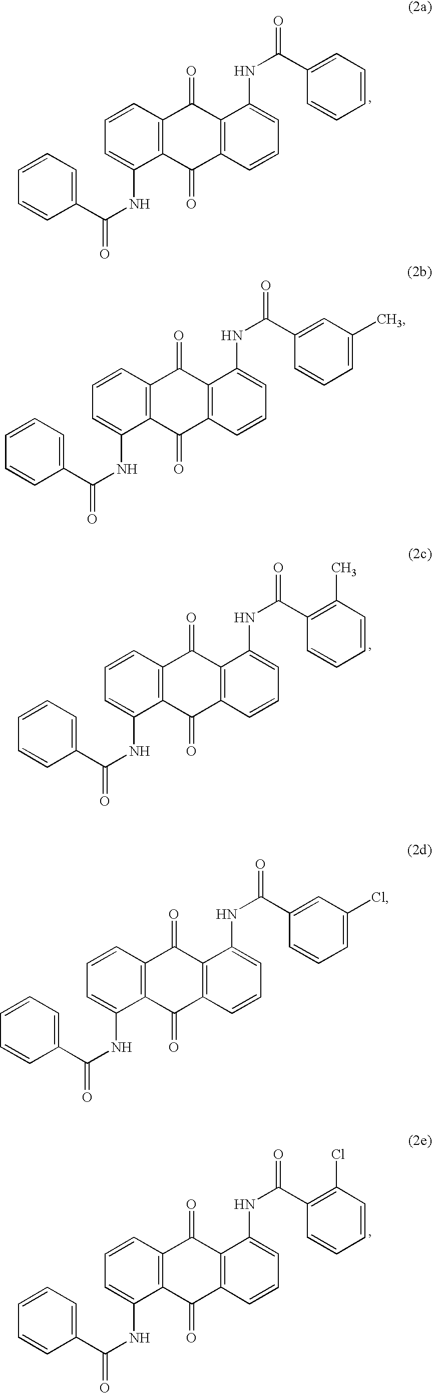 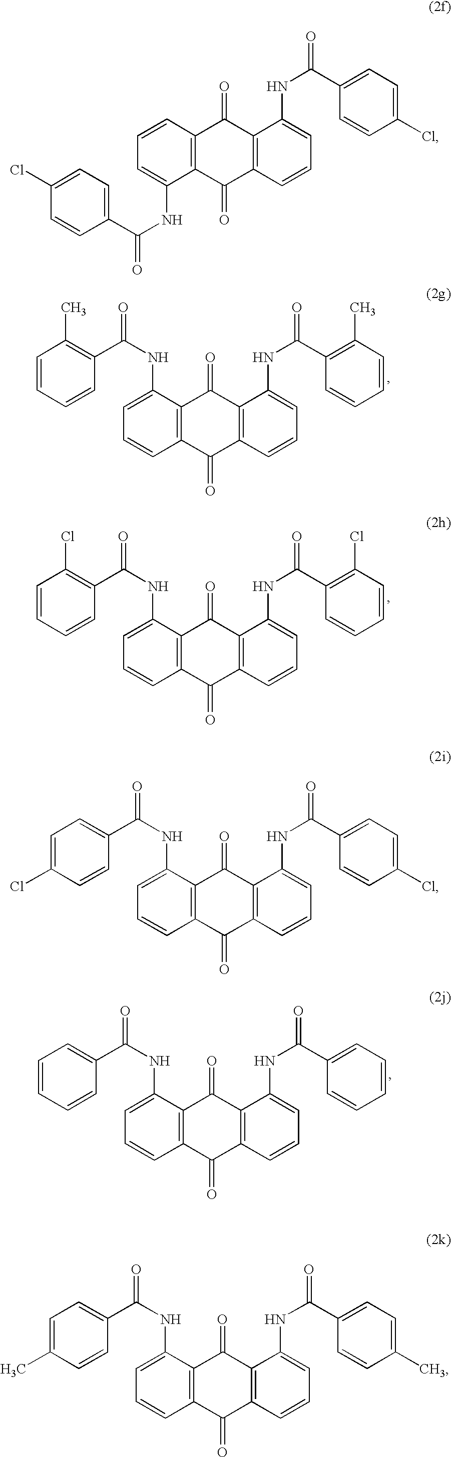 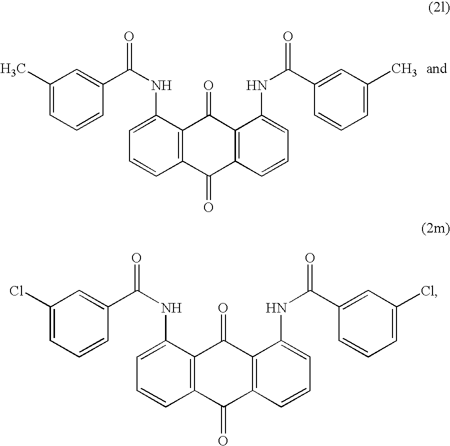
especially of formula (2a).

Suitable dyes of formula (3) are, for example, the dyes of formulae 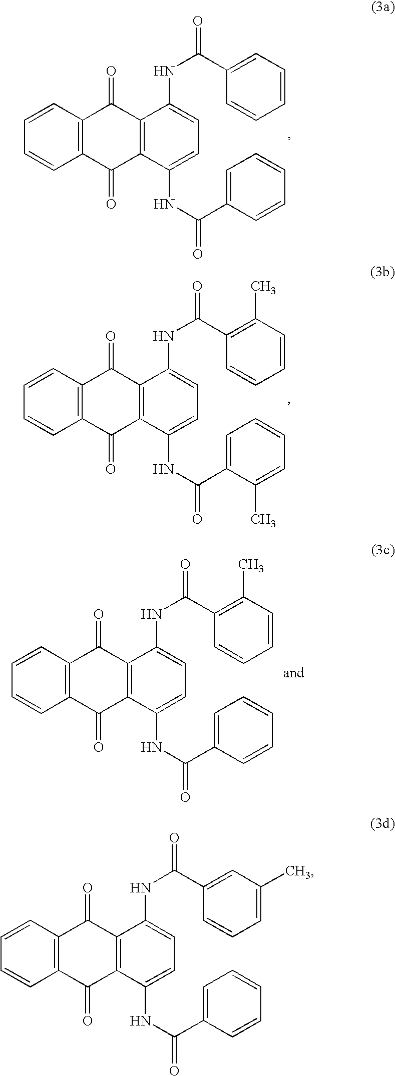
especially of formula (3a).

Suitable dyes of formula (4) are, for example, the dyes of formulae 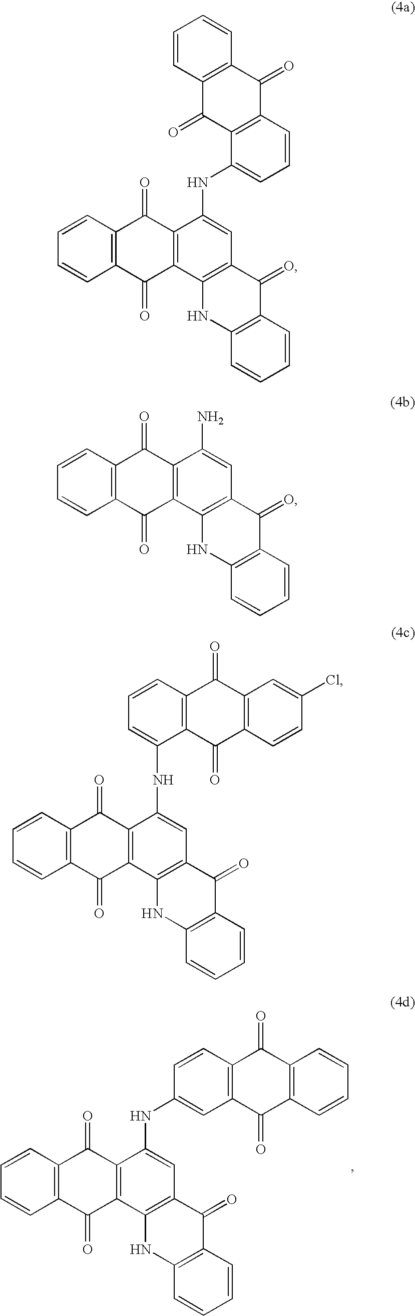 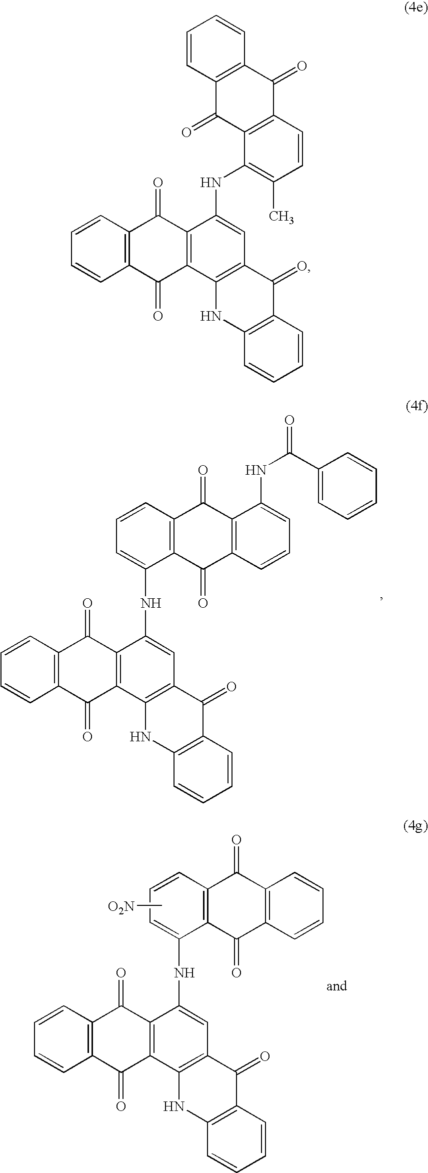 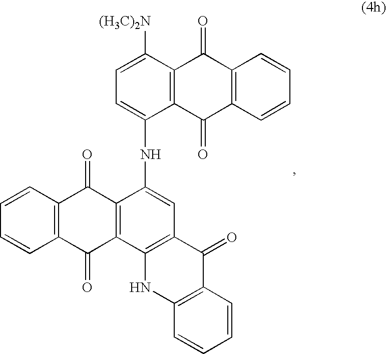
especially of formula (4a).

In the process according to the invention there are preferably used two or three vat dyes from the group of formulae (1), (2), (3) and (4).

In the process according to the invention, one of the vat dyes is, for example, the dye of formula (1).

The process according to the invention is carried out at a pH of, for example, from 10.2 to 11.8, preferably from 10.8 to 11.6.

The pH can be adjusted by using, for example, sodium hydroxide or sodium carbonate as the alkali.

The amount of vat dye mixture added to the dye liquor is governed by the desired tinctorial strength. In general, amounts of from 0.001 to 25% by weight, preferably from 0.01 to 20% by weight and especially from 0.1 to 15% by weight, based on the weight of the cellulosic fibre material used, have proved suitable.

In addition to the vat dye mixture and the alkali, the dye liquors comprise auxiliary chemicals conventionally used in vat dyeing. Special mention is to be made of reducing agents, a suitable reducing agent being, for example, a hydrosulfite (dithionite), e.g. sodium dihydro-sulfite (sodium dithionite).

The dye liquor may additionally comprise further dyeing auxiliaries, for example electrolytes, such as sodium chloride or sodium sulfate, or commercially available wetting, levelling and dispersing agents.

The vat dye mixture can be applied from an aqueous solution by the pad-dyeing or exhaust methods conventional in vat dyeing. The pad-dyeing method is preferred. The liquor ratio is dependent on the equipment parameters, on the substrate and on the make-up. It can vary within wide ranges, for example from 1:4 to 1:100, preferably from 1:6 to 1:20.

The dyeing process can be carried out at temperatures of, for example, from 20 to 110° C., especially from 20 to 80° C. The process according to the invention is preferably carried out at about 20° C., i.e. room temperature. A heating device for heating the dye liquor is not required in this process.

The dyeing process is advantageously carried out continuously in a plurality of passes. A plurality of passes means at least two, three, four, five or six passes, preferably at least four, five or six passes. For example, eight, nine or ten passes, as the upper limit, are carried out. Preference is given to dyeing in from four to ten passes, especially from six to eight passes.

The dyeing process according to the invention can advantageously be carried out using conventional types of machine, for example a hank dyeing machine or an open-width dyeing machine, which are very widely used in industrial indigo dyeing.

There come into consideration as cellulosic fibre materials especially cellulose that has not been pretreated, for example hemp, linen, natural cotton, as well as fibre blends, for example acrylic/cotton or polyester/cotton blends. Fibre materials based on regenerated cellulose (viscose) are also suitable. The cellulose material may be in many different processing forms, for example in the form of loose stock, yarn, woven material, nonwoven material or knitted fabrics.

By means of the process according to the invention, cellulosic fibre material, for example yarn in the form of a hank or rope or in the form of a warp sheet, can be dyed in non-indigoid colour shades in an advantageous and reliable manner.

The vat dye mixtures used in the process according to the invention are novel. The invention accordingly relates also to dye mixtures comprising at least two dyes from the group of formulae (1), (2), (3) and (4), the definitions and preferred meanings mentioned above applying in respect of each of the variables in the mentioned formulae. The dye mixture according to the invention preferably comprises two or three vat dyes from the group of formulae (1), (2), (3) and (4).

The vat dyes of formulae (1), (2), (3) and (4) are distinguished by the fact that they can readily be combined with one another.

The dyeings obtained using the process according the invention or the dyes according to the invention are distinguished by a high degree of fastness to rubbing and good levelness and also exhibit good colour yields, good fastness to light and good fastness to wetting properties. By means of the process according to the invention it is possible to produce heavily ring-dyed warp yarn which, after appropriate treatment, exhibits the desired “stone-wash” effect.

The Examples which follow serve to illustrate the invention. Temperatures are given in degrees Celsius, parts are parts by weight and percentages refer to % by weight, unless indicated otherwise. The relationship between parts by weight and parts by volume is the same as that between kilograms and litres.

### EXAMPLE 1

100 ml of a dye liquor (vat) are prepared by dispersing in water 20 g/l of a dye formulation comprising 10% by weight finely ground pigment of formula (2a) and 10% by weight dispersing agent. 40 g/l of a dye formulation comprising 10% by weight finely ground pigment of formula (3a) and 10% by weight dispersing agent are additionally dispersed in the mixture. 16 g/l of calcined sodium carbonate and 4 g/l of sodium hydrosulfite (sodium dithionite) are then dissolved in the resulting mixture. 4 g of a piece of 100% bleached cotton fabric are immersed for 20 seconds in the dye liquor, which is maintained at room temperature. The piece of fabric is then squeezed out on a padding machine to a liquor pick-up of 70% and, for reoxidation of the dye, developed for 80 seconds in air.

The steps of immersion, squeezing out and skying are carried out a total of eight times using the same piece of fabric and the same dye liquor, during which the pH of the dye liquor is maintained at from 11.3 to 11.4 by the periodic addition of 10% sodium hydroxide solution. The dyeing is then subjected to cold and hot rinsing and subsequently dried.

There is obtained a level, tinctorially strong orange-coloured cotton dyeing which has the typical ring-like dye distribution in the fibre cross-section, in which the dyes are located only at the surface of the fibres (visible by means of a microscope). The dyeing produces the wear pattern typical in “stone-wash” treatments, like that in commercial, conventional denim goods.

### EXAMPLE 2

If the procedure described in Example 1 is followed but, instead of the dye formulations described therein, there are used 30 g/l of a dye formulation comprising 10% by weight finely ground pigment of formula (4a) and 10% by weight dispersing agent, 10 g/l of a dye formulation comprising 10% by weight finely ground pigment of formula (3a) and 10% by weight dispersing agent, and 5 g/l of a dye formulation comprising 10% by weight finely ground pigment of formula (2a) and 10% by weight dispersing agent, there is obtained a level, tinctorially strong brown cotton dyeing which has the typical ring-like dye distribution in the fibre cross-section, in which the dyes are located only at the surface of the fibres (visible by means of a microscope). The dyeing produces the wear pattern typical in “stone-wash” treatments, like that in commercial, conventional denim goods.

### EXAMPLE 3

If the procedure described in Example 1 is followed but, instead of the dye formulations described therein, there are used 30 g/l of a dye formulation comprising 10% by weight finely ground pigment of formula (4a) and 10% by weight dispersing agent, 5 g/l of a dye formulation comprising 10% by weight finely ground pigment of formula (3a) and 10% by weight dispersing agent, and 20 g/l of a dye formulation comprising 10% by weight finely ground pigment of formula (2a) and 10% by weight dispersing agent, and if the amount of sodium carbonate is increased to 20 g/l and the amount of sodium hydrosulfite to 6 g/l, there is obtained a level, tinctorially strong olive-green cotton dyeing which has the typical ring-like dye distribution in the fibre cross-section, in which the dyes are located only at the surface of the fibres (visible by means of a microscope). The dyeing produces the wear pattern typical in “stone-wash” treatments, like that in commercial, conventional denim goods.

### EXAMPLE 4

If the procedure described in Example 1 is followed but, instead of the dye formulations described therein, there are used 20 g/l of a dye formulation comprising 10% by weight finely ground pigment of formula (4a) and 10% by weight dispersing agent, and 60 g/l of a dye formulation comprising 10% by weight finely ground pigment of formula (3a) and 10% by weight dispersing agent, and if the amount of sodium carbonate is increased to 20 g/l and the amount of sodium hydrosulfite to 6 g/l, there is obtained a level, tinctorially strong brown cotton dyeing which has the typical ring-like dye distribution in the fibre cross-section, in which the dyes are located only at the surface of the fibres (visible by means of a microscope). The dyeing produces the wear pattern typical in “stone-wash” treatments, like that in commercial, conventional denim goods.

### EXAMPLE 5

If the procedure described in Example 1 is followed but, instead of the dye formulations described therein, there are used 70 g/l of a dye formulation comprising 10% by weight finely ground pigment of formula (4a) and 10% by weight dispersing agent, and 5 g/l of a dye formulation comprising 10% by weight finely ground pigment of formula (1) and 10% by weight dispersing agent, and if the amount of sodium carbonate is increased to 20 g/l and the amount of sodium hydrosulfite to 6g/l, there is obtained a level, tinctorially strong black cotton dyeing which has the typical ring-like dye distribution in the fibre cross-section, in which the dyes are located only at the surface of the fibres (visible by means of a microscope). The dyeing produces the wear pattern typical in “stone-wash” treatments, like that in commercial, conventional denim goods.

### EXAMPLE 6

If the procedure described in Example 1 is followed but, instead of the dye formulations described therein, there are used 5 g/l of a dye formulation comprising 10% by weight finely ground pigment of formula (1) and 10% by weight dispersing agent, and 10 g/l of a dye formulation comprising 10% by weight finely ground pigment of formula (2a) and 10% by weight dispersing agent, there is obtained a level, tinctorially strong green cotton dyeing which has the typical ring-like dye distribution in the fibre cross-section, in which the dyes are located only at the surface of the fibres (visible by means of a microscope). The dyeing produces the wear pattern typical in “stone-wash” treatments, like that in commercial, conventional denim goods.

### EXAMPLES 7 to 12

If the procedure described in Examples 1 to 6 is followed but a piece of 100% raw cotton fabric is used instead of a piece of 100% bleached cotton fabric, there are likewise obtained level, tinctorially strong cotton dyeings which have the typical ring-like dye distribution in the fibre cross-section, in which the dyes are located only at the surface of the fibres (visible by means of a microscope). The dyeing produces the wear pattern typical in “stone-wash” treatments, like that in commercial, conventional denim goods.

### EXAMPLES 13 to 19

If the procedure described in Examples 1 to 6 is followed but a hank of 100% raw cotton, linked at the ends, is used instead of a piece of 100% bleached cotton fabric, there are likewise obtained level, tinctorially strong cotton dyeings which have the typical ring-like dye distribution in the fibre cross-section, in which the dyes are located only at the surface of the fibres (visible by means of a microscope). The dyeing produces the wear pattern typical in “stone-wash” treatments, like that in commercial, conventional denim goods.

### EXAMPLES 20 to 31

Level, tinctorially strong orange-coloured cotton dyeings having the typical ring-like dye distribution in the fibre cross-section, in which the dyes are located only at the surface of the fibres, are likewise obtained if the procedure described in Example 1 is followed but, instead of a dye formulation comprising a pigment of formula (2a), the same amount of a corresponding formulation comprising a pigment of formula (2b), (2c), (2d), (2e), (2f), (2g), (2h), (2i), (2j), (2k), (2l) or (2m) is used. The dyeing produces the wear pattern typical in “stone-wash” treatments, like that in commercial, conventional denim goods.

### EXAMPLES 32 to 34

Level, tinctorially strong orange-coloured cotton dyeings having the typical ring-like dye distribution in the fibre cross-section, in which the dyes are located only at the surface of the fibres, are likewise obtained if the procedure described in Example 1 is followed but, instead of a dye formulation comprising a pigment of formula (3a), the same amount of a corresponding formulation comprising a pigment of formula (3b), (3c) or (3e) is used. The dyeing produces the wear pattern typical in “stone-wash” treatments, like that in commercial, conventional denim goods.

### EXAMPLES 35 to 41

Level, tinctorially strong brown cotton dyeings having the typical ring-like dye distribution in the fibre cross-section, in which the dyes are located only at the surface of the fibres, are likewise obtained if the procedure described in Example 2 is followed but, instead of a dye formulation comprising a pigment of formula (4a), the same amount of a corresponding formulation comprising a pigment of formula (4b), (4c), (4d), (4e), (4f), (4g) or (4h) is used. The dyeing produces the wear pattern typical in “stone-wash” treatments, like that in commercial, conventional denim goods.

### EXAMPLE 42

500 ml of dye liquor (vat) are prepared by dispersing in water 0.40 g of a dye formulation comprising 20% by weight finely ground pigment of formula (2a) and 10% by weight dispersing agent, and 0.30 g of a dye formulation comprising 20% by weight finely ground pigment of formula (3a) and 10% by weight dispersing agent, and 0.51 g of a dye formulation comprising 30% by weight finely ground pigment of formula (4a) and 10% by weight dispersing agent. 0.2 g of sodium hydrosulfite (sodium dithionite) is added thereto and dissolved. By dropwise addition of a sodium hydroxide solution (30% by weight), pH 11.6 is established and maintained for 20 minutes. 2 g of 100% bleached cotton warp yarn are immersed for 20 seconds in the dye liquor, which is maintained at room temperature. The piece of warp yarn is then immediately squeezed out on a padding machine to a liquor pick-up of 70% and allowed to develop for 80 seconds in air (reoxidation of the dye). The steps of immersion, squeezing out and skying are carried out a total of 8 times using the same piece of warp yarn and the same dye liquor. The pH of the dye liquor is maintained at from 11.5 to 11.6 by the periodic addition of 10% sodium hydroxide solution. The dyeing is then subjected to cold and hot rinsing and subsequently dried. A level khaki-coloured cotton dyeing having the typical surface dye distribution in the fibre cross-section (visible by means of a microscope) is obtained. The dyeing also produces the wear pattern typical in stone-wash treatments, like that in commercial, conventional denim goods.

### EXAMPLE 43

500 ml of dye liquor (vat) are prepared by dispersing in water 1.94 g of a dye formulation comprising 20% by weight finely ground pigment of formula (2a) and 10% by weight dispersing agent, and 3.16 g of a dye formulation comprising 20% by weight finely ground pigment of formula (3a) and 10% by weight dispersing agent, and 5.54 g of a dye formulation comprising 30% by weight finely ground pigment of formula (4a) and 10% by weight dispersing agent. 1.9 g of sodium hydrosulfite (sodium dithionite) are added thereto and dissolved. By dropwise addition of a sodium hydroxide solution (30% by weight), pH 11.6 is established and maintained for 20 minutes. 2 g of 100% bleached cotton warp yarn are immersed for 20 seconds in the dye liquor, which is maintained at room temperature. The piece of warp yarn is then immediately squeezed out on a padding machine to a liquor pick-up of 70% and allowed to develop for 80 seconds in air (reoxidation of the dye). The steps of immersion, squeezing out and skying are carried out a total of 8 times using the same piece of warp yarn and the same dye liquor. The pH of the dye liquor is maintained at from 11.5 to 11.6 by the periodic addition of 10% sodium hydroxide solution. The dyeing is then subjected to cold and hot rinsing and subsequently dried. A level deep-brown cotton dyeing having the typical surface dye distribution in the fibre cross-section (visible by means of a microscope) is obtained. The dyeing also produces the wear pattern typical in stone-wash treatments, like that in commercial, conventional denim goods.

### EXAMPLE 44

500 ml of dye liquor (vat) are prepared by dispersing in water 0.74 g of a dye formulation comprising 20% by weight finely ground pigment of formula (2a) and 10% by weight dispersing agent, and 0.10 g of a dye formulation comprising 20% by weight finely ground pigment of formula (3a) and 10% by weight dispersing agent, and 1.29 g of a dye formulation comprising 30% by weight finely ground pigment of formula (4a) and 10% by weight dispersing agent. 0.4 g of sodium hydrosulfite (sodium dithionite) is added thereto and dissolved. By dropwise addition of a sodium hydroxide solution (30% by weight), pH 11.6 is established and maintained for 20 minutes. 2 g of 100% bleached cotton warp yarn are immersed for 20 seconds in the dye liquor, which is maintained at room temperature. The piece of warp yarn is then immediately squeezed out on a padding machine to a liquor pick-up of 70% and allowed to develop for 80 seconds in air (reoxidation of the dye). The steps of immersion, squeezing out and skying are carried out a total of 8 times using the same piece of warp yarn and the same dye liquor. The pH of the dye liquor is maintained at from 11.5 to 11.6 by the periodic addition of 10% sodium hydroxide solution. The dyeing is then subjected to cold and hot rinsing and subsequently dried. A level mid-green cotton dyeing having the typical surface dye distribution in the fibre cross-section (visible by means of a microscope) is obtained. The dyeing also produces the wear pattern typical in stone-wash treatments, like that in commercial, conventional denim goods.

### EXAMPLE 45

500 ml of dye liquor (vat) are prepared by dispersing in water 1.13 g of a dye formulation comprising 20% by weight finely ground pigment of formula (4b) and 10% by weight dispersing agent, and 0.85 g of a dye formulation comprising 20% by weight finely ground pigment of formula (3a) and 10% by weight dispersing agent. 0.4 g of sodium hydrosulfite (sodium dithionite) is added thereto and dissolved. By dropwise addition of a sodium hydroxide solution (30% by weight), pH 11.6 is established and maintained for 20 minutes. 2 g of 100% bleached cotton warp yarn are immersed for 20 seconds in the dye liquor, which is maintained at room temperature. The piece of warp yarn is then immediately squeezed out on a padding machine to a liquor pick-up of 70% and allowed to develop for 80 seconds in air (reoxidation of the dye). The steps of immersion, squeezing out and skying are carried out a total of 8 times using the same piece of warp yarn and the same dye liquor. The pH of the dye liquor is maintained at from 11.5 to 11.6 by the periodic addition of 10% sodium hydroxide solution. The dyeing is then subjected to cold and hot rinsing and subsequently dried. A level lilac-coloured cotton dyeing having the typical surface dye distribution in the fibre cross-section (visible by means of a microscope) is obtained. The dyeing also produces the wear pattern typical in stone-wash treatments, like that in commercial, conventional denim goods.

1. A process for dyeing cellulosic fibre materials, wherein the fibre material is brought into contact with at least two dyes from the group of formulae 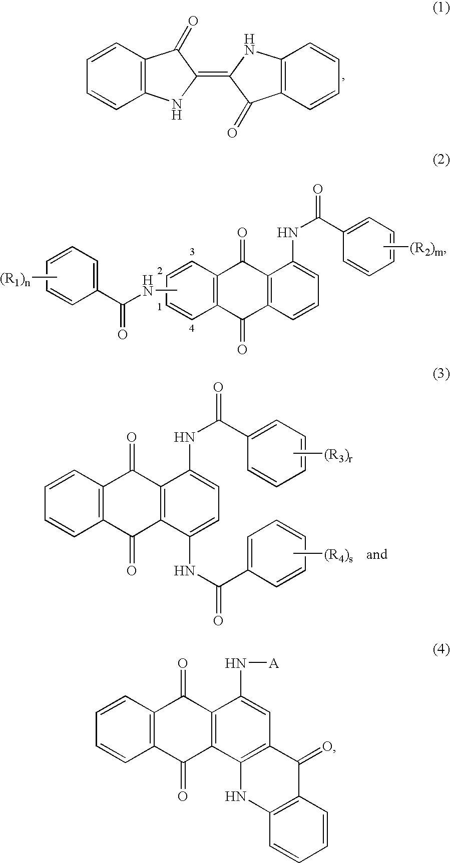
wherein
A is hydrogen or a radical of formula 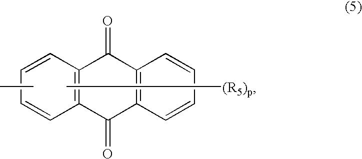
R₁, R₂, R₃ and R₄ are each independently of the others halogen, C₁-C₄alkyl or C₁-C₄alkoxy,
R₅ is halogen, C₁-C₄alkyl, C₁-C₄alkoxy, nitro, benzoylamino which is unsubstituted or substituted in the phenyl ring, or unsubstituted or substituted amino,
n, m, r and s are each independently of the others the number 0, 1 or 2, and
p is the number 0, 1, 2, 3 or 4.

2. A process according to claim 1, wherein
R₁, R₂, R₃, R₄ and R₅ are each independently of the others halogen or C₁-C₄alkyl.

3. A process according to claim 1, wherein
n, m, r and s are each independently of the others 0 or 1.

4. A process according to claim 1, wherein
p is the number 0°, 1 or 2.

5. A process according to claim 1, wherein dyeing is carried out at a pH of from 10.2 to 11.8.

6. A process according to claim 1, wherein dyeing is carried out at a pH of from 10.8 to 11.6.

7. A process according to claim 1, wherein the dyes are applied by the pad-dyeing method.

8. A process according to claim 1, wherein the dyeing process is carried out continuously in a plurality of passes.

9. A process according to claim 1, wherein the dyeing process is carried out on a hank dyeing machine or an open-width dyeing machine.

10. A dye mixture comprising at least two dyes from the group of formulae 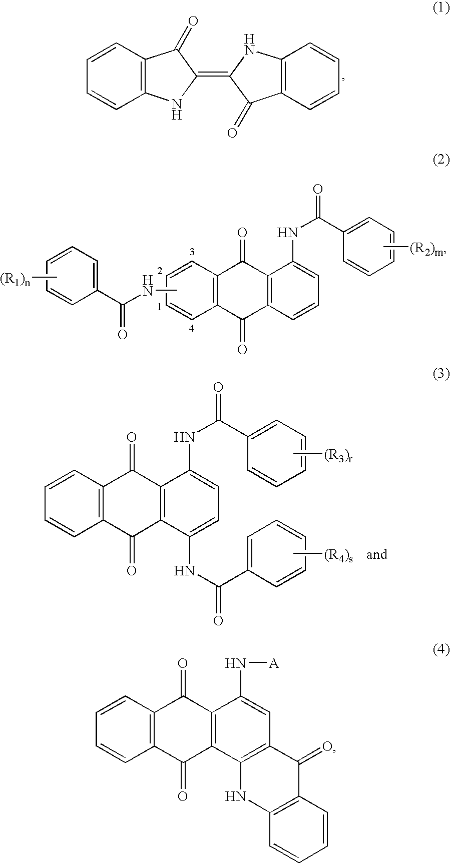
wherein
A is hydrogen or a radical of formula 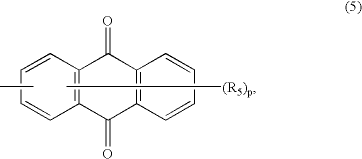
R₁, R₂, R₃ and R₄ are each independently of the others halogen, C₁-C₄alkyl or C₁-C₄alkoxy,
R₅ is halogen, C₁-C₄alkyl, C₁-C₄alkoxy, nitro, benzoylamino which is unsubstituted or substituted in the phenyl ring, or unsubstituted or substituted amino,
n, m, r and s are each independently of the others the number 0, 1 or 2, and
p is the number 0, 1, 2, 3 or 4.

11. A process according to claim 1, wherein
R₁, R₂, R₃, R₄ and R₅ are each independently of the others chlorine or methyl.
